(19) United States
(12) Patent Application Publication
(10) Pub. No.: US 2026/0187335 A1
(43) Pub. Date: Jul. 2, 2026

(54) METHOD AND WEARABLE DEVICE FOR PROVIDING INFORMATION BASED ON CONTEXT

(71) Applicant: ThinkAR Pte Ltd., Taipei City (TW)

(72) Inventors: Zhou Ye, Taipei City (TW); Diomedes Kastanis, Singapore (SG)

(73) Assignee: ThinkAR Pte Ltd., Taipei City (TW)

(21) Appl. No.: 19/006,251

(22) Filed: Dec. 31, 2024

(51) Int. Cl. G06F 40/103; G06F 1/16; G06F 3/01; G06F 16/2457; G06F 16/248; G06F 40/30

(52) U.S. Cl. CPC G06F 40/103; G06F 1/163; G06F 3/011; G06F 16/24578; G06F 16/248; G06F 40/30

(57) ABSTRACT

Methods and a wearable device are provided. A response of a query is generated. The query is divided into several segments. An entropy of each segment is calculated. The segments are displayed when their entropy is greater than a threshold. In addition, a display format of the response is determined based on an index which is calculated according to context information and display information of the corresponding display format.

### BACKGROUND

### Technical Field

The disclosure is related to methods and a wearable device for providing rich and important information based on context and entropy calculation.

### Description of Related Art

Existing wearable devices, such as glasses and head-mounted displays, have made significant progress in the fields of virtual reality (VR), augmented reality (AR), and mixed reality (MR). These devices provide users with immersive experiences by visually enhancing the integration of virtual and real-world content. As the variety of application scenarios expands, dynamically adjusting the displayed content based on context has become an important demand. Current technologies largely rely on fixed display modes and content layouts, which limit users' experiences in different environments. For example, in outdoor settings, excessive virtual information can interfere with the observation of the real environment, and displaying too much information on glasses can also make it difficult to read.

### SUMMARY

Embodiments of the present disclosure provide a method performed by a wearable device. The method includes: receiving a query from a user, and generating a response having at least one term, according to the query; obtaining context information and display information corresponding to a display format, wherein the context information includes user context information and environment context information; calculating a weight of each term of the response based on at least part of the context information and the display information; calculating a screen impact based on at least part of the context information and the display information; calculating a comprehensiveness of each term of the response, and a relevance between each term of the response and the query; calculating an index of the display format according to each of the weight, each of the comprehensiveness, each of the relevance, and the screen impact; and when the index of the display format meets a first condition, displaying the response on a display according to the display format.

From another aspect, embodiments of the present disclosure provide a method performed by a wearable device. The method includes: receiving a query from a user, and generating a response according to the query; dividing the response into a plurality of segments; obtaining context information including user context information and environment context information; calculating an entropy of each of the segments according to the user context information; calculating an entropy threshold according to the context information; and for each of the segments, when the entropy of the corresponding segment is greater than the entropy threshold, displaying the segment.

From another aspect, embodiments of the present disclosure provide a wearable device including a display, a memory, and processor. The memory stores multiple instructions. The processor is electrically connected to the memory for executing the instructions to perform steps of: receiving a query from a user, and generating a response having at least one term, according to the query; obtaining context information and display information corresponding to a display format, wherein the context information includes user context information and environment context information; calculating a weight of each term of the response on at least part of the context information and the display information; calculating a screen impact based on at least part of the context information and the display information; calculating a comprehensiveness of each term of the response, and a relevance between each term of the response and the query; calculating an index of the display format according to the weight, the comprehensiveness, the relevance, and the screen impact; and when the index of the display format meets a first condition, displaying the response on a display according to the display format.

To make the aforementioned more comprehensible, several embodiments accompanied with drawings are described in detail as follows.

### BRIEF DESCRIPTION OF THE DRAWINGS

FIG. 1 illustrates a schematic view of various wearable devices.

FIG. 2 is a schematic system diagram of a wearable device according to one embodiment.

FIG. 3 is a flowchart of a method according to a first embodiment.

FIG. 4 is a schematic diagram illustrating a Markov network according to an embodiment.

FIG. 5 is a flowchart of a method based on a second embodiment.

FIG. 6 is a flowchart of a method according to another embodiment.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

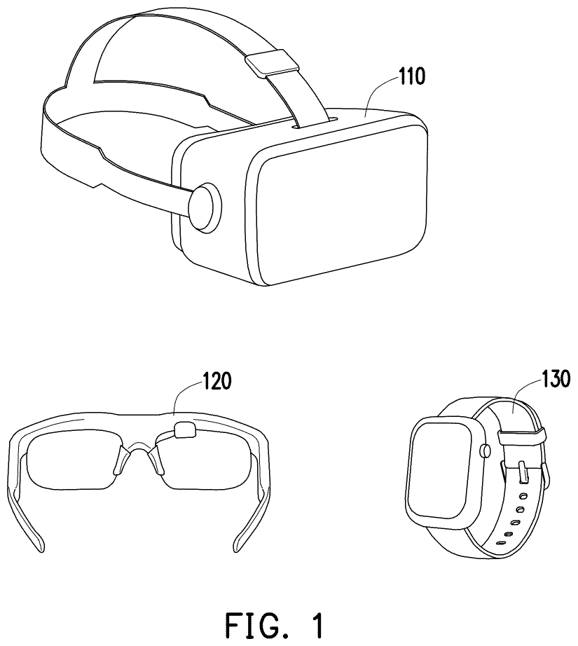

FIG. 1 illustrates a schematic view of various wearable devices. The disclosed wearable device may be a head-mounted device 110, smart glasses 120, smart watch 130, etc. Each of these wearable devices is equipped with at least one display and multiple sensors. The display can be a see-through display or a non-see-through display, where the see-through display can overlay digital images onto real-world images, allowing users to view virtual information alongside the real world. The non-see-through display may include an Liquid Crystal Display (LCD) panel, Organic Light Emitting Display (OLED) panel, or electronic paper panel, but is not limited to these. The aforementioned sensors may include an inertial measurement unit (IMU), Global Positioning System (GPS), Photoplethysmography (PPG) sensor, Electrocardiography (ECG) sensor, temperature sensor, pressure sensor, light sensor, color temperature sensor, microphone, infrared sensor, and others. The inertial sensor may include an accelerometer and a gyroscope, among other components. The types and quantities of the sensors in the wearable device are not limited in the present disclosure.

The aforementioned sensors can be used to collect environment context information, which includes motion information, brightness information, time information, and device information. For instance, the motion information may include speed, acceleration, angular acceleration, angular velocity, orientation, and device location. The brightness information may include brightness and color temperature of ambient light. The time information may include time and date. The device information may include remaining battery capacity, network speed, and computational capability. In certain embodiments, the environment context information may also include environmental temperature and pressure. In some embodiments, the environment context information may also include various news content, such as the fluctuation rates of stock, bond, and foreign exchange markets, or whether the day is a holiday.

On the other hand, the wearable device also collects user context information, which may include user preference and user activity. The user preference may include topics of interest, frequently traveled running routes, prices of specific products or markets, and stores frequently visited. The user activity may include whether the user is in motion or stationary, current exercises being performed, ways of transportation, and schedule.

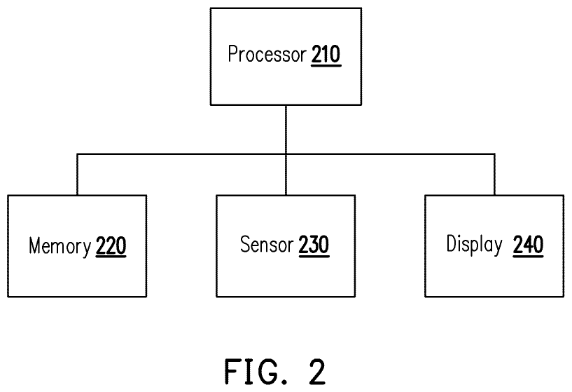

FIG. 2 is a schematic system diagram of a wearable device according to one embodiment. Referring to FIG. 2, a wearable device 200 includes a processor 210, memory 220, sensors 230, and a display 240. The processor 210 may be a central processing unit, microprocessor, microcontroller, Application Specific Integrated Circuit (ASIC), or Programmable Logic Device (PLD). The memory 220 may be random-access memory, read-only memory, or flash memory, where multiple instructions are stored. The sensors 230 and display 240 have been described above and will not be described here. For simplicity, not all units of the wearable device 200 are shown. For instance, the wearable device 200 may contain a communication module including circuits that enable connectivity options such as internet, cellular network, Near Field Communication (NFC), infrared communication, Bluetooth, and Wi-Fi.

The processor 210 executes the instructions stored in the memory 220 to perform multiple methods mentioned in the following embodiments. These methods can determine the content or display format on the wearable device based on the context information. Multiple embodiments will be illustrated below.

### First Embodiment

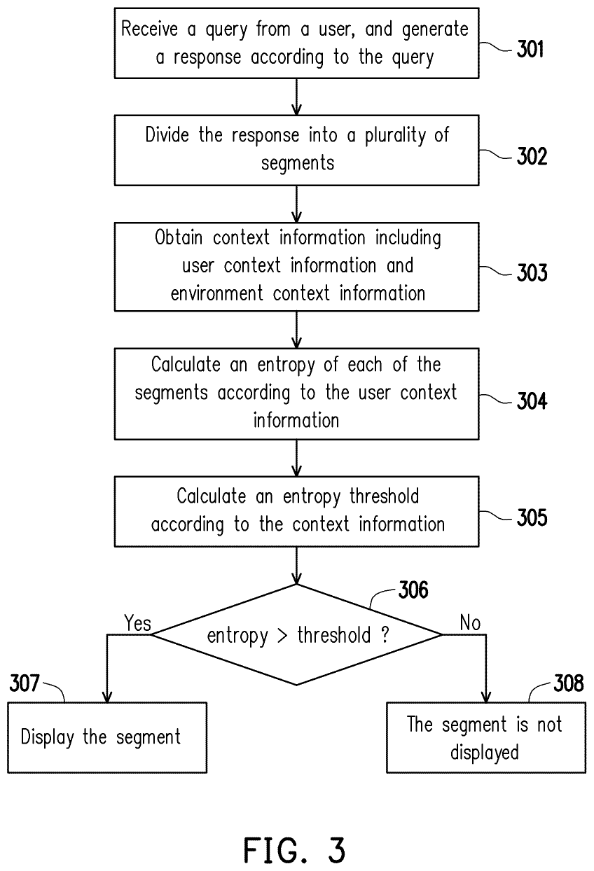

In the first embodiment, entropy is used to determine the content to be displayed. FIG. 3 is a flowchart of the method according to the first embodiment.

At step 301, a query from the user is received, and a response is generated based on the query. For example, the user may input the query via voice, which is then converted to text. Next, the query is input in text form into a language model or a search engine to obtain the response. The language model could be from the BERT series, GPT series, etc., which is not limited in the disclosure. For example, the query may be “how is the stock market,” and the response may be “The stock market showed significant volatility in the last quarter. The S&P 500 index experienced a 15% drop, while tech stocks saw a major sell-off due to rising interest rates. Additionally, the Federal Reserve hinted at possible rate hikes in the near future.”

At step 302, the response is divided into multiple segments. Any suitable natural language processing algorithm can be used for this, such as sentence boundary detection, chunk detection, or segmenting based on punctuation. Alternatively, the response may be input into a large language model to request segmentation into multiple segments. In some embodiments, the large language model is asked to condense each segment to create shorter segments without altering the meaning. In certain embodiments, latent Dirichlet allocation (LDA) can be performed to identify topics within the response and segment it by topic. In other embodiments, RAKE (Rapid Automatic Keyword Extraction) may be applied to extract keywords from segments, forming multiple segments based on these keywords. For example, using the above query, four segments may be extracted as follows: i) “Stock market showed volatility in the last quarter.”; ii) “S&P 500 index dropped 15%.”; iii) “Tech stocks sold off due to rising interest rates.”; and iv) “Federal Reserve hinted at rate hikes.”

At step 303, context information is obtained. The context information includes user context information and environment context information, which have been previously described and will not be reiterated here.

At step 304, an entropy for each segment is calculated based on the user context information. Each response contains multiple terms. In certain embodiments, a weight and a probability of each term are calculated to determine a weighted entropy, as shown in Equation 1 below.

$${H}_{w} ( X ) = - \sum {w}_{i} * p ( {x}_{i} ) * log p ( {x}_{i} ) \qquad [ Equation 1 ]$$

where xᵢ denotes the i-th term, and i is a positive integer. p(xᵢ) represents the probability of the i-th term, and wᵢ is the weight associated with the i-th term. H_{w}(X) is the weighted entropy of a segment.

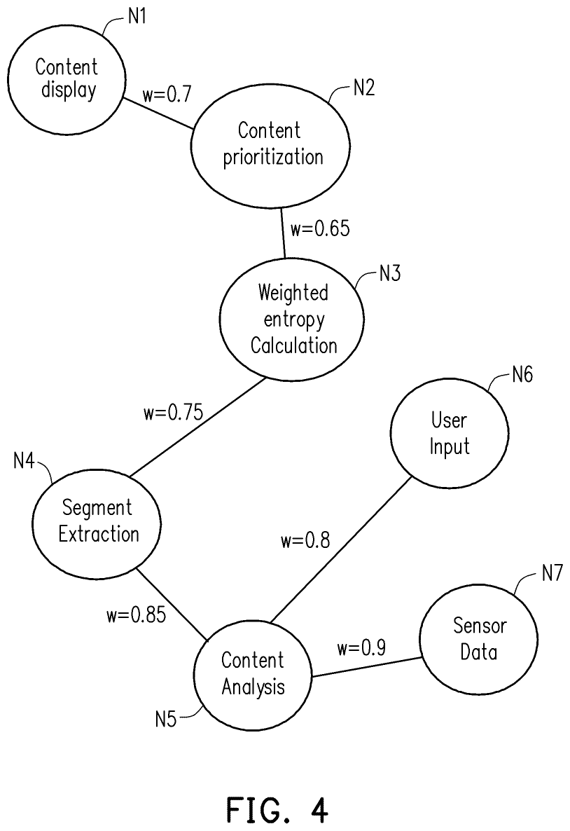

In some embodiments, the probability p(xᵢ) is calculated based on the user context information. For example, the probability of finance-related content may be increased according to the user preferences, or the probability of content related to specific products, movies, information, or locations may be adjusted. Similarly, if the user activity indicates the user is currently engaged in outdoor activities or traveling, the probability of weather-related information may be increased. In certain embodiments, a Markov network is used to calculate the probability. For instance, a cyclic non-homogeneous Markov network, as illustrated in FIG. 4, may be employed. This network 400 comprises multiple nodes N1-N7, representing “Content display,” “Content prioritization,” “Weighted entropy Calculation,” “Segment Extraction,” “Content Analysis,” “User Input,” and “Sensor Data”, respectively. Using this Markov network, a joint probability distribution can be defined, enabling the calculation of marginal probabilities. The edges between the nodes correspond to the weights respectively, indicating the dependency between the nodes, where a higher dependency implies a greater probability of joint occurrence. For example, the weight between the nodes N5 and N6 is 0.8, indicating that user input impacts the content analysis; conversely, the weight between the nodes N5 and N7 is 0.9, meaning the sensor data also affects the content analysis. For instance, a high acceleration value suggests that the user is engaged in physical activity, causing the content analysis at node N5 to assign a lower probability to longer segments and a higher probability to shorter segments. This Markov network 400 can adjust display content based on the context information. However, FIG. 4 is merely an example, and this invention does not limit the method for calculating the probability of each term. In other embodiments, Bayesian networks or neural networks may also be used to determine the probability of each term.

The wᵢ in Equation 1 is calculated based on the term's importance. For a given term, a first importance is calculated based on a corpus, followed by a second importance determined using a large language model and the context information. For example, the first importance can be calculated using term frequency-inverse document frequency (TF-IDF), which measures the importance of a term in the corpus. Generally, a term appearing more frequently in a document and less frequently in other documents is considered to have greater importance. Additionally, a large language model may evaluate the term's importance by receiving the term and the context information as input, providing a score between 0 and 1. Subsequently, the weight assigned to each term can be determined based on the first importance and second importance, as shown in Equation 2 below.

$${w}_{i} = α \cdot TF - IDF ( {x}_{i} ) + β \cdot Contextual Importance ( {x}_{i} ) \qquad [ Equation 2 ]$$

Here, α and β are real numbers whose sum equals to 1, such as both being set to 0.5. TF-IDF(xᵢ) represents the first importance, while Contextual Importance(xᵢ) represents the second importance. In certain embodiments, the weight value ranges between 0 and 1.

After calculating the weight wᵢ and the probability p(xᵢ), the entropy of a segment can be computed using Equation 1. For example, for the segment “S&P 500 index dropped 15%,” which contains five terms: “S&P,” “500,” “index,” “dropped,” and “15%,” the probabilities of these terms are 0.3, 0.2, 0.1, 0.2, and 0.2, respectively, while their weights are 0.7, 0.7, 0.5, 0.5, and 0.7, respectively. Accordingly, the entropy calculation becomes: −(0.7*0.3*log(0.3)+0.7*0.2*log(0.2)+0.5*0.1*log(0.1)+0.5*0.2*log(0.2)+0.7*0.2*log(0.2)=0.4532. In this entropy calculation, the context information is factored in, with higher entropy indicating richer and more relevant information in the given context.

In Step 305 of FIG. 3, an entropy threshold is calculated based on the context information. Various methods, such as rule-based models, Bayesian models, or neural networks, can be employed to determine the entropy threshold. For instance, the entropy threshold may be increased when detecting dim ambient light, high acceleration, user fatigue, or elevated stress levels. In some embodiments, the entropy threshold may also be determined by the size of the display on the wearable device or by the ambient noise level. These adjustments are merely examples, and the disclosure is not limited to them. In certain embodiments, an ontological framework may be used to define or classify context information, which is continuously updated based on new context information and user inputs.

In Step 306, each segment's entropy is compared against the entropy threshold. If the entropy exceeds the threshold, Step 307 displays the segment; otherwise, it proceeds to Step 308, where the segment is not displayed. Therefore, only segments with sufficiently rich and important information are displayed, as they surpass the entropy threshold.

### Second Embodiment

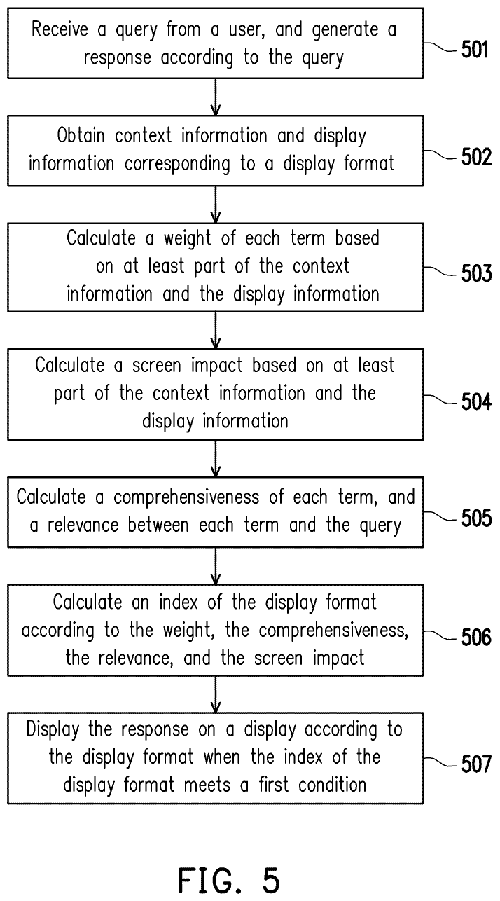

FIG. 5 illustrates a method flowchart based on the second embodiment. Referring to FIG. 5, in step 501, a query from the user is received, and a response is generated based on this query. This response contains at least one term. The step 501 is similar to the step 301 in FIG. 3 and will not be described again here.

In step 502, context information and display information corresponding to a display format are obtained. The context information has already been explained in the first embodiment and will not be described here. The display format's display information may include information of content in forms such as images, text, tables, or animations. For images, the display information may include the image size, resolution, and type (e.g., a simple graphic or a more complex illustration). For text, the display information may include text color, font, and size. For tables, the display information may include table size and type (e.g., a histogram or line chart). In some embodiments, multiple display formats (also called candidate display formats) are set, and the display information for each candidate display format is obtained, with the display information possibly differing. For example, a first display format may display content in an image or table, while a second display format may use text. Alternatively, the font size in the first display format may be larger than in the second display format.

In step 503, the weight of each term is calculated based on at least part of the context information and the display information. In some embodiments, only the context information is used to calculate the weight. For example, the weight can be calculated using the above Equation 2. In some embodiments, only the display information is used to calculate the weight. For instance, when discussing stock market fluctuations, different colors (red and green) may be used, with other text in black or white, thereby assigning a higher weight to red or green terms. In certain embodiments, both context information and display information are used to calculate the weight, such as assigning higher weights to terms of user interest and terms displayed in specific colors.

In step 504, a screen impact is calculated based on at least part of the context information and the display information. This screen impact is a numerical value indicating whether a particular display format is suitable for displaying on the display 240 in a given context. For example, when the user is running (as indicated by the context information), a simple graphic display is appropriate (as indicated by the display information). Alternatively, when the user is stationary, a more detailed text description is suitable. The display size, resolution, and type of the display 240 (e.g., transparent or non-transparent) are obtained here. When the display 240 is smaller, shorter sentences are more appropriate. If the display 240 is transparent, the content displayed should not occupy too much space. In certain embodiments, the screen impact value ranges between 0 and 1.

In step 505, the comprehensiveness of each term in the response, as well as the relevance between the query and the term, is calculated. In some embodiments, the response can be input into a large language model, which is instructed to evaluate whether the response is easy to understand. The large language model can return a numerical value representing the comprehensiveness. Relevance can be calculated through a comparison of feature vectors. Specifically, the feature vector of the query is first computed, followed by the feature vector of the response. The cosine similarity between these two feature vectors is then calculated as a measure of relevance between the term and the query. In some embodiments, the relevance value ranges from −1 to 1. The aforementioned feature vectors can be computed using a machine learning model, such as a convolutional neural network, recurrent neural network (RNN), or transformer, which is not limited in the disclosure. In other embodiments, Mel-Frequency Cepstral Coefficients (MFCCs) can also be calculated as feature vectors.

In step 506, an index of the display format is calculated based on the aforementioned weight, comprehensiveness, relevance, and screen impact. In some embodiments, the calculation of this index is as shown in the following Equation 3.

$$CKCI = {{\sum }_{i = 1}}^{n} \frac{{w}_{i} \cdot {Relevance}_{i} \cdot {Comprehensiveness}_{i}}{n} - Screen\_Impact \qquad [ Equation 3 ]$$

Where CKCI is the index, also referred to as the contextual knowledge and comprehension index (CKCI). n is the number of terms in the response. wᵢ is the weight of the i-th term. Relevanceᵢ is the relevance of the i-th term. Comprehensivenessᵢ is the comprehensiveness of the i-th term. Screen_Impact is the screen impact. In this embodiment, a larger index indicates that the corresponding response is more suitable for rendering on the display.

In step 507, when the index meets a first condition, the response is displayed on the display according to the display format. In some embodiments, multiple candidate display formats are set in step 502, and these candidate display formats undergo steps 503 to 506 to obtain their corresponding indices. If any candidate display format's index meets the first condition, the response is displayed according to the corresponding candidate display format. The first condition may be defined as the greatest index among the indexes of all candidate display formats. For example, when the user's query is related to climate change and two candidate display formats are presented: one as a chart and the other as text, if the index corresponding to the chart is higher than the index corresponding to the text, the response will be displayed in the form of the chart.

In the above method, factors such as context information and screen impact are taken into consideration, allowing for appropriate content to be provided to the user. For instance, if the user's query is “How did the stock market perform last quarter?” and the user is running while wearing glasses, the content displayed on the display 240 would be “S&P 500: −15% YoY,” accompanied by a voice from a speaker “The stock market showed significant volatility last quarter with the S&P 500 dropping by 15 percent year over year.” Conversely, if the user is in a quiet environment, the displayed content would be “The stock market showed significant volatility in the last quarter. The S&P 500 index experienced a 15% drop, while tech stocks saw a major sell-off due to rising interest rates. Additionally, the Federal Reserve hinted at possible rate hikes in the near future.”

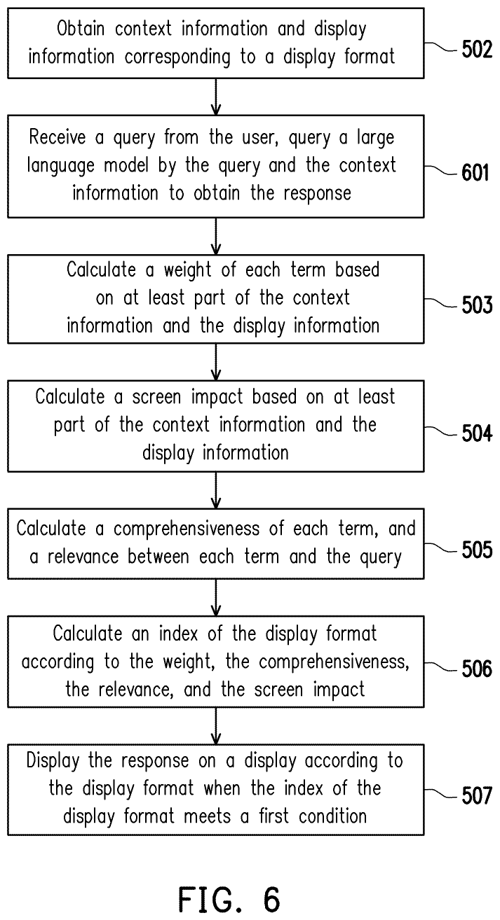

FIG. 6 is a flowchart illustrating the method according to another embodiment. Referring to FIG. 6, the process begins by executing step 502 before proceeding to step 601. In step 601, a query is received from the user, and a large language model is queried by the query and the context information to obtain the response. In other words, when using the large language model, relevant context information is also provided to the model, meaning that it will consider the calculation of CKCI as mentioned above. For example, when the user is running and prefers audio output and concise information, if the query is “Summarize the impact of climate change in a short audio clip,” the response generated by the large language model could be, “Global temperatures have risen by 1.2 degrees Celsius since 1880. Major causes include emissions, industrial activities, and deforestation.” In this example, the calculated CKCI is 0.72.

On the other hand, if the context information that the user is running and prefers audio output and concise information is not considered, and the query is “Tell me about climate change,” the response from the large language model might be, “Climate change refers to long-term shifts in temperatures and weather patterns. These shifts may be natural, such as through variations in the solar cycle. However, since the 1800s, human activities have been the main driver of climate change, primarily due to burning fossil fuels like coal, oil, and gas.” In this case, the calculated CKCI is 0.3. These two examples illustrate that incorporating CKCI considerations can make responses more suitable for the context.

To ensure the system operates with minimal latency, at least one of the following techniques is employed: parallel processing, in-memory processing, caching, and efficient algorithms. The following will provide further details on these aspects.

Parallelism involves dividing a task into subtasks that can be processed concurrently, thereby reducing the overall processing time. It includes two approaches: i) Multi-threading: Utilize multiple threads within a single process to handle different tasks simultaneously, such as content segmentation, CKCI calculation, and multi-modal presentation; ii) Multi-processing: Use multiple processes to handle computationally intensive tasks independently, taking advantage of multi-core processors. Parallelism is based on Amdahl's Law, which states that the theoretical speedup of a task is limited by the portion of the task that cannot be parallelized. By maximizing the parallelizable portion of the workload, we can achieve significant performance gains.

In-memory processing involves keeping data in the main memory (RAM) to avoid the latency associated with disk I/O operations. It includes two approaches: i) Use data structures such as arrays, hash maps, and in-memory databases to store frequently accessed data and intermediate computation results; ii) Implement data caching strategies to reduce redundant data processing. In-memory processing leverages the fact that accessing data in RAM is orders of magnitude faster than accessing data on disk. This is based on the memory hierarchy principle, where different storage types have different access speeds.

Caching stores frequently accessed data and computation results in a temporary storage area to reduce the need to recompute or fetch data from slower storage. It includes two approaches: i) Implement caching mechanisms at various levels, including application-level caching, database caching, and distributed caching using systems like Redis or Memcached; ii) Use cache invalidation strategies to ensure the cache remains up-to-date. Caching is based on the principle of temporal locality, which states that recently accessed data is likely to be accessed again in the near future. By storing such data in a cache, we can significantly reduce access times.

Using optimized algorithms ensures that computational tasks are performed in the most efficient manner possible, minimizing processing time and resource usage. It includes two approaches: i) Natural Language Processing (NLP): Use optimized algorithms and models for tasks such as tokenization, part-of-speech tagging, and named entity recognition. For instance, use pre-trained transformer models like BERT and GPT-4, which are optimized for parallel processing on modern hardware; ii) Entropy Calculations: Implement efficient mathematical algorithms for entropy calculations, such as using logarithmic and exponential function approximations. The efficiency of algorithms is often analyzed using Big O notation, which describes the upper bound of an algorithm's time complexity. By choosing algorithms with lower time complexity, we can ensure faster execution times.

The proposed wearable devices and methods can dynamically determine the displayed content based on context information, and the use of entropy calculations allows for the filtering of more important and rich information. The two embodiments described above can be implemented together. For instance, the first embodiment can be used to determine which segments to display, and then the second embodiment can be employed to decide the display format for those segments.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method performed by a wearable device, the method comprising:
receiving a query from a user, and generating a response having at least one term, according to the query;
obtaining context information and display information corresponding to a display format, wherein the context information comprises user context information and environment context information;
calculating a weight of each term of the response based on at least part of the context information and the display information;
calculating a screen impact based on at least part of the context information and the display information;
calculating a comprehensiveness of each term of the response, and a relevance between each term of the response and the query;
calculating an index of the display format according to each of the weight, each of the comprehensiveness, each of the relevance, and the screen impact; and
when the index of the display format meets a first condition, displaying the response on a display according to the display format.

2. The method of claim 1, wherein the method further comprises:
for a first term of the at least one term, calculating a first importance according to a corpus, calculating a second importance according to a large language model and the context information, and calculating the weight corresponding to the first term according to the first importance and the second importance.

3. The method of claim 2, wherein the first importance is a term frequency-inverse document frequency (TF-IDF).

4. The method of claim 3, further comprising:
calculating a first feature vector of the query, and calculating a second feature vector of the response; and
calculating a cosine similarity between the first feature vector and the second feature vector as the relevance between each term of the response and the query.

5. The method of claim 4, further comprising:
inputting the response into the large language model to obtain the comprehensiveness.

6. The method of claim 1, wherein the index is calculated based on a following equation:
$$CKCI = {\sum }_{i = 1}^{n} \frac{{w}_{i} \cdot {Relevance}_{i} \cdot {Comprehensiveness}_{i}}{n} - Screen\_Impact$$
wherein CKCI is the index, n is a number of the at least one term, wᵢ is an i-th weight, Relevanceᵢ is the relevance, Comprehensivenessᵢ is the comprehensiveness, and Screen_Impact is the screen impact.

7. The method of claim 6, further comprising:
setting a plurality of candidate display formats;
obtaining display information corresponding to each of the candidate display formats;
for each of the candidate display formats, calculating a weight of each term of the response based on at least part of the context information and the corresponding display information;
for each of the candidate display formats, calculating a screen impact based on at least part of the context information and the corresponding display information;
for each of the candidate display formats, calculating a comprehensiveness of each term of the response, and a relevance between each term of the response and the query;
calculating an index of each of the candidate display formats, according to the corresponding weight, the corresponding comprehensiveness, the corresponding relevance, and the corresponding screen impact; and
when the index of any of the candidate display formats meets the first condition, displaying the response on the display according to the corresponding candidate display format, wherein the first condition indicates a greatest index among the indexes of the candidate display formats.

8. The method of claim 1, wherein the user context information comprises user preference and a user activity, and the environment context information comprises motion information, brightness information, time information, and device information.

9. The method of claim 1, wherein generating the response according to the query comprises:
querying a large language model by the query and the context information to obtain the response.

10. A method performed by a wearable device, the method comprising:
receiving a query from a user, and generating a response according to the query;
dividing the response into a plurality of segments;
obtaining context information comprising user context information and environment context information;
calculating an entropy of each of the segments according to the user context information;
calculating an entropy threshold according to the context information; and
for each of the segments, when the entropy of the corresponding segment is greater than the entropy threshold, displaying the segment.

11. The method of claim 10, wherein each of the segments comprises a plurality of terms, the step of calculating the entropy of each of the segments according to the user context information comprises:
for each of the terms, calculating a first importance according to a corpus, calculating a second importance according to a large language model and the context information, and calculating a weight corresponding to the term according to the first importance and the second importance;
for each of the terms, determining a probability; and
calculating a weighted entropy of each of the segments according to the weights of the terms of the segment and the probabilities of the terms of the segment.

12. The method of claim 11, wherein the first importance is a term frequency-inverse document frequency (TF-IDF).

13. The method of claim 11, further comprising:
calculating the probabilities based on a Markov network.

14. The method of claim 10, wherein the user context information comprises a user preference and a user activity, and the environment context information comprises motion information, brightness information, time information, and device information.

15. A wearable device, comprising:
a display;
a memory storing a plurality of instructions; and
a processor electrically connected to the memory for executing the instructions to perform steps of:
receiving a query from a user, and generating a response having at least one term, according to the query;
obtaining context information and display information corresponding to a display format, wherein the context information comprises user context information and environment context information;
calculating a weight of each term of the response on at least part of the context information and the display information;
calculating a screen impact based on at least part of the context information and the display information;
calculating a comprehensiveness of each term of the response, and a relevance between each term of the response and the query;
calculating an index of the display format according to the weight, the comprehensiveness, the relevance, and the screen impact; and
when the index of the display format meets a first condition, displaying the response on a display according to the display format.

16. The wearable device of claim 15, wherein the steps further comprise:
for a first term of the terms, calculating a first importance according to a corpus, calculating a second importance according to a large language model and the context information, and calculating the weight corresponding to the first term according to the first importance and the second importance.

17. The wearable device of claim 16, wherein the steps further comprise:
calculating a first feature vector of the query, and calculating a second feature vector of the response; and
calculating a cosine similarity between the first feature vector and the second feature vector as the relevance between each term of the response and the query.

18. The wearable device of claim 17, further comprising:
inputting the response into the large language model to obtain the comprehensiveness.

19. The wearable device of claim 15, wherein the index is calculated based on a following equation:
$$CKCI = {\sum }_{i = 1}^{n} \frac{{w}_{i} \cdot {Relevance}_{i} \cdot {Comprehensiveness}_{i}}{n} - Screen\_Impact$$
wherein CKCI is the index, n is a number of the at least one term, wᵢ is an i-th weight, Relevanceᵢ is the relevance, Comprehensivenessᵢ is the comprehensiveness, and Screen_Impact is the screen impact.

20. The wearable device of claim 19, wherein the processor is further configured to perform the steps of:
setting a plurality of candidate display formats; and
obtaining display information corresponding to each of the candidate display formats;
for each candidate display format, calculating a weight of each term of the response based on at least part of the context information and the corresponding display information;
for each candidate display format, calculating a screen impact based on at least part of the context information and the corresponding display information;
for each candidate display format, calculating a comprehensiveness of each term of the response, and a relevance between each term of the response and the query;
calculating an index of each of the candidate display formats, according to each of the weight, each of the comprehensiveness, each of the relevance, and the screen impact; and
when the index of any of the candidate display formats meets the first condition, displaying the response on the display according to the corresponding candidate display format,
wherein the first condition indicates a greatest index among the indexes of the candidate display formats.
